(19) United States
(12) Patent Application Publication
(10) Pub. No.: US 2010/0051686 A1
(43) Pub. Date: Mar. 4, 2010

(54) System and method for authenticating a transaction using a one-time pass code (OTPK)

(75) Inventor: Valentine Obi, Lagos (NG)

Correspondence Address: BUCHANAN, INGERSOLL & ROONEY PC, POST OFFICE BOX 1404, ALEXANDRIA, VA, 22313-1404, US

(73) Assignee: Covenant Visions International Limited, Lagos (NG)

(21) Appl. No.: 12/230,524

(22) Filed: Aug. 29, 2008

(51) Int. Cl. G06Q 40/00

(52) U.S. Cl. 235/379

(57) ABSTRACT

Provided is a system and method for authenticating a financial transaction using a dynamic code tied to a preset monetary limit. The dynamic code is generated at the user's mobile device and linked to the preset monetary limit. The user uses the generated dynamic code instead of his or her static automated teller machine (ATM) personal identification number (PIN). The dynamic code, transaction data, and financial account data are transmitted to a validating entity for authorization of the transaction. If the withdrawal request exceeds the preset monetary limit, a request is sent to the user's mobile device for an additional authorization of the new amount or the transaction is rejected based on the information in the user's profile. The dynamic code may also be generated for use in Internet transactions and web payment transactions.

### FIELD OF THE INVENTION

This invention relates generally to a system and method for authenticating a transaction based on a dynamically generated code tied to a user-set monetary limit using a mobile phone.

### BACKGROUND OF THE INVENTION

Utilization of a static personal identification number (PIN) as the singular parameter for ATM transactions is increasingly becoming fraud prone. Card cloning and PIN interception (either electronically or through observation of the user inputting the PIN, or from disclosure through intimidation or fraud) are readily apparent threats to card based transactions. The likelihood of fraud is commensurately higher during remote transactions than in face-to-face or “card-present” transactions due to the lower security and ease of committing fraud during remote transactions. Also, common credit, debit and automated teller machine (ATM) cards are not used to transfer funds from one person to another, as done with services such as provided by Western Unions and the like.

One approach in minimizing fraud has been the use of a dynamic code (e.g., a code that changes periodically) generated by Two-factor (2FA) tools such as smart cards and USB tokens. Two-factor authentication establishes the identity of the user through possession of a smart card or USB token, and knowledge of a PIN code (e.g., an ATM PIN code). The user's authentication credentials (e.g., PKI keys and certificates, static passwords, or one time passwords) are stored within the device. A user inserts his or her smart card (or USB token) into a reader and type in his or her PIN code to enable authentication. The smart card or USB token generates a dynamic code using secret data, as well as other transaction data, stored in the memory thereon. The data is then transmitted to an authorization location for verification that the dynamic code was generated by the smart card or USB token associated with the account number used in the transaction.

However, smart cards and USB tokens are relatively more expensive to manufacture in comparison to traditional transaction cards having a magnetic stripe. In addition, smart cards and USB tokens require a reader to be used during each transaction, which require upgrading or acquiring additional hardware for existing point of sale terminals that are designed for magnetic stripe cards. Adoption of smart card and USB token technology has been slow, particularly in the United States.

Further, there is a need to be able to provide cash from people who have bank accounts to third parties who might not want or be able to use traditional bank transfers or other money transfer mechanisms.

### SUMMARY OF THE INVENTION

Exemplary embodiments of the invention allow the generation of a dynamic code for setting a user-defined cash withdrawal limit on ATM transactions by a combination of a secret, user-known code or PIN, physical possession of both a mobile telephone and a transaction card, and the generation of a dynamic code based on the user's PIN, data associated with the mobile phone, data on a transaction card held by the user, and permitting the user to provide the dynamic code for conducting a transaction based on a limit set by the user. In this way, no additional equipment is needed for the average user, given that they likely already have a mobile phone.

According to exemplary embodiments, a method for authenticating a financial transaction may comprise retrieving and storing an identification data parameter associated with a mobile device at the mobile device, receiving a PIN from a user at the mobile device, generating a dynamic variable that is determinable at more than one location at the mobile device, calculating an One-Time Pass Code (OTPK) based on the identification data parameter, the PIN, and the dynamic variable at the mobile device, associating the OTPK with a monetary limit amount, and providing the OTPK to be used at a financial institution or ATM for withdrawing monetary funds up to the monetary limit amount.

According to exemplary embodiments, a method for authenticating a financial transaction may comprise receiving and storing at a server an identification data parameter associated with a mobile device and a PIN, generating at the server a dynamic variable that is determinable at more than one location, transmitting the dynamic variable to the server to be used in decrypting the messages from the mobile device and authorizing the transaction, and receiving at the server an authorization request to authorize the transaction, in which the request may include at least an unique financial account identifier, the OTPK generated by the mobile device, and a monetary limit amount associated with the OTPK generated by the mobile device. The method may further include determining whether the OTPK was generated by the mobile device based on the identification data parameter, the PIN, and the dynamic variable, authorizing the transaction request in response to the determination result, and transmitting transaction and financial account data to a validating authority for authorization of the transaction.

A system for authenticating a financial transaction may comprise an authorization database receiving and storing an identification data parameter associated with a mobile device, a transaction card, and a PIN, a dynamic variable generator that generates a dynamic variable that is determinable at more than one location, and a receiver that receives an authorization request to authorize a transaction, in which the request may include at least an unique financial account identifier, the OTPK generated by the mobile device, and a monetary limit amount associated with the OTPK. The system may further comprise a processor determining whether the OTPK was generated by the mobile device based on the identification data parameter, the PIN, and the dynamic variable, and for authorizing the transaction request in response to the determination result, and an output device transmitting transaction and financial account data to a validating authority for authorization of the transaction.

### BRIEF DESCRIPTION OF THE DRAWINGS

Exemplary embodiments will be more clearly understood from the following detailed description taken in conjunction with the accompanying drawings. FIGS. 1-3 represent non-limiting, exemplary embodiments as described herein.

FIGS. 1-2 are flow charts illustrating a method for authenticating a financial transaction tied to a preset monetary limit according to exemplary embodiments.

FIG. 3 is a diagram illustrating a system environment for authenticating a financial transaction tied to a preset monetary limit according to exemplary embodiments.

### DETAILED DESCRIPTION OF THE INVENTION

For simplicity and illustrative purposes, principles of the invention are described by referring mainly to exemplary embodiments thereof. The exemplary embodiments mainly refer to transactions performed over a cellular communications network. However, one of ordinary skill in the art would readily recognize that the same principles are equally applicable to other types of transactions including transactions over a computer network (e.g., the Internet), WiFi and other wireless communication networks, land-line telephone network, and etc., provided that the mobile phone (e.g., any communication device including mobile phones, combination e-mail and wireless phone and potentially other functionality such as Blackberries, certain voice communication-enabled PDAs, iPhones, etc.) has a unique number or combination of numbers associated and stored on it and is capable of carrying out computer processing.

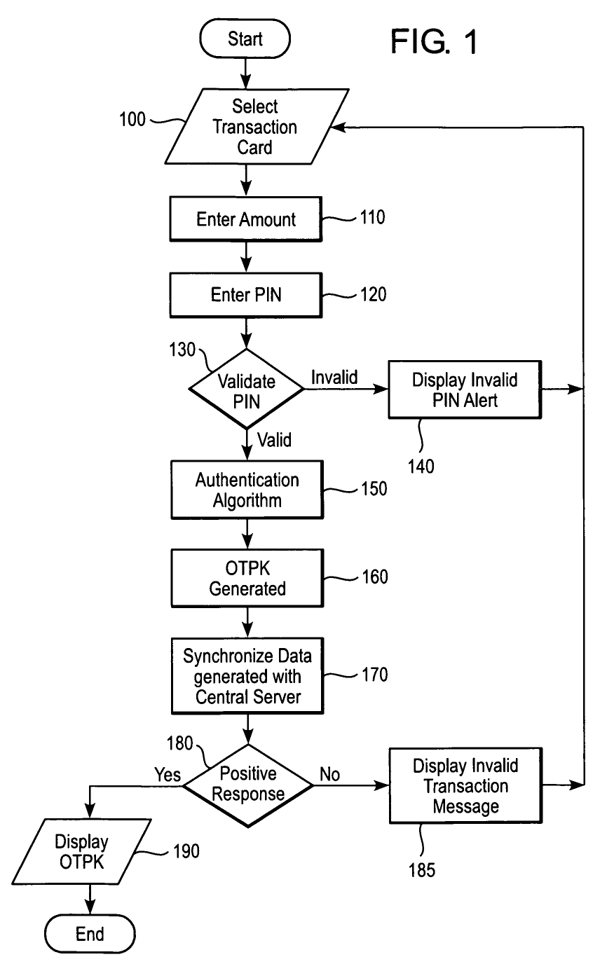

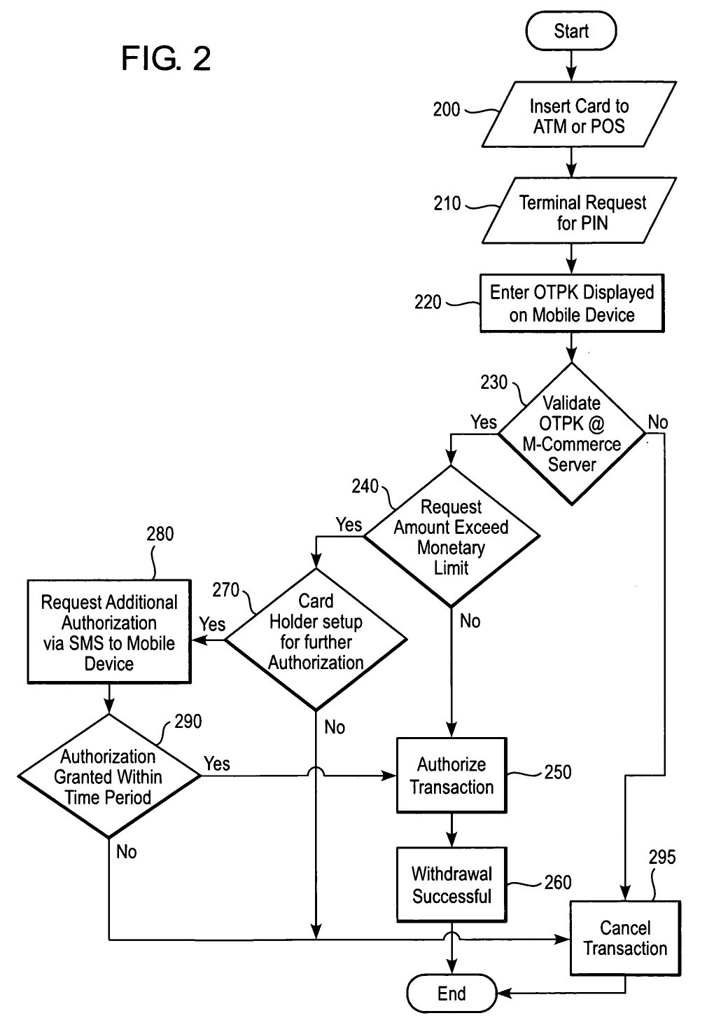

FIGS. 1-2 is a flow chart illustrating a method for authenticating a financial transaction using a dynamically generated authentication code tied to a preset monetary limit according to exemplary embodiments.

An exemplary embodiment of the invention may include a user initiating a transaction at an automated teller machine (ATM) using a transaction card issued by a participating bank or a card issuer office. The user may request a transaction card from any participating bank or card issuer office. The request is processed by the issuer, and a transaction card is issued to the user. The transaction card issued is mapped to the cardholder's mobile phone in configuring the cardholder's financial account for mobile transactions, and can be ATM cards, debit cards, credit cards, or combinations thereof, for example. It should be noted that any suitable device, system, or scheme for requesting or performing a transaction can be used in place of the mobile phone, including a personal computer or other mobile device, for example, as identified above.

The cardholder then downloads a mCommerce application to the mobile phone and sets up his or her cellular phone for mCommerce and mobile banking transactions. The mCommerce application may also be pushed to the cardholder's mobile phone. The mCommerce application may provide a user friendly navigational tool for mCommerce transactions and security services. During the application setup, the cardholder's mobile phone is synchronized with the mCommerce central server. A private key is also generated and shared with the central server. This key is then used for encryption of data during subsequent transactions sessions. The mCommerce application may enforce that the private key is regenerated and shared with the central server on a periodic basis, for example, every 30 days. In addition, a feature of the mCommerce application may enable the cardholder to resync or regenerate a new private key on demand.

Referring to FIG. 1, in steps 100, 110, and 120, the cardholder selects the particular card for the transaction, enters all necessary information including the amount and his or her ATM static PIN on the mCommerce enabled mobile phone to generate a new four digit dynamic passcode for that transaction.

The mobile device determines whether the PIN is valid in step 130 by comparing the PIN with data stored on the device. If the PIN is invalid, then an invalid PIN message is displayed in step 140. Otherwise, in steps 150 and 160, the PIN is valid and the new passcode, a One-Time Pass Code (“OTPK”), is generated dynamically by the mCommerce application on the mobile phone using an authentication algorithm and data including the mobile phone identifier and a dynamic variable. The dynamic variable may be a random number, a one-way hash of the proposed transaction amount, may be based on current date and time, any other data that is not easily predictable, or any combination thereof. The authentication algorithm may be any suitable application cryptogram, which can include those generally well known in the art.

In step 170, the mCommerce application encrypts and packages the information entered as a secure SMS message, and synchronizes the amount and the passcode (OTPK) generated with the mCommerce server via a GPRS or SMS instantly. In step 180, if the synchronization is not successful, then an invalid transaction message is displayed in step 185. Otherwise, the OTPK is displayed in step 190. It should be noted that the dynamic passcode is not limited to being a four digit passcode, and thus, the passcode could consist of any number of digits or characters. It should also be noted that the mCommerce application can allow for unlimited number of transaction cards (depending on the cellular phone memory capacity) to be used on one cellular phone.

Referring to FIG. 2, in steps 200 and 210, the cardholder inserts his or her transaction card into an ATM or a merchant's point of sale terminal (POS), and is prompted by the ATM to enter his or her PIN. In step 220, the cardholder enters the OTPK generated on the mobile phone as the PIN for the ATM transaction. The OTPK is used in the place of the static ATM PIN. In this case, the cardholder or another person can receive cash money from the ATM using the account holder's card or a substantial duplicate of the account holder's card, provided either or both the transaction had not been previously carried out or within a predetermined period (e.g., several seconds for greater security and certainty, but also to hours or even days) of the generation of the OTPK.

If the other person decides to withdraw more than the preset limit, a request is sent to the cardholder's mobile device for an additional authorization of this new amount.

In step 230, the OTPK generated by the mobile device and the transaction data are encrypted and transmitted to a mCommerce central server for authentication and validation via SMS or GPRS, for example. If the authentication and validation are not successful, then the transaction is cancelled in step 295. Message transmission between the mobile device and the mCommerce central server may be secured using DES encryption, for example, to ensure user integrity and security over the public network.

The mCommerce central server (e.g., central switch) decrypts the transmitted data and the transaction is authenticated using the parameters contained in the decrypted message. The mCommerce central server then transmits transaction and financial account data to a validating authority or issuer for authorization of the transaction.

If should be noted that the static ATM PIN is not used for live transactions. It is replaced with the OTPK generated for that transaction.

In step 240, it is determined whether the requested amount exceeds the preset limit stored at the mCommerce server. If the requested amount does not exceed the preset limit, the transaction is authorized in step 250 and the funds are transferred in step 260. However, if the requested amount exceeds the preset limit, the cardholder's profile is checked to see if the cardholder is setup for further authorization in step 270. If the cardholder is not, then the transaction is cancelled. Otherwise, a request is sent to the cardholder's mobile device for an additional authorization of this new amount in step 280. In step 290, if the authorization is not granted within a predetermined or given time period, then the transaction is cancelled automatically.

An exemplary embodiment of the invention may include the cardholder initiating a web (e.g., Internet) transaction. The cardholder generates an OTPK for web login use using his or her mobile phone. The cardholder logs into the computer system using his or her username and password. The system then prompts for the OTPK generated on the mobile phone. On entry of the OTPK, the cardholder is logged in if the OTPK is valid for that cardholder.

An exemplary embodiment of the invention may also include the cardholder initiating a payment transaction via the web. The cardholder generates an OTPK for the web payment transaction using his or her mobile phone. The cardholder then enters his or her financial transaction card (or uses a swipe or other input mechanism) and perhaps a PIN for authentication of the user. The system prompts the cardholder for the OTPK to authorize the transaction.

According to exemplary embodiments, there may be several ways of implementing authorization of a web payment transaction utilizing the OTPK. Depending on the type of implementation by the issuer or validating authority, the cardholder may be asked to enter a PIN or just the OTPK instead of the PIN. For example, the cardholder may decide that any payment above a certain amount requires his or her OTPK for authorization. This information may be stored in the cardholder's user profile. Thus, for any amount below this set amount, the cardholder's PIN is sufficient. But, for any amount above this set amount, the OTPK is required. The issuer or validating authority may decide that all transactions require an OTPK, which may override any setup by the cardholder. Moreover, the system may follow the strongest authentication rule as setup by any of the stakeholders (e.g., cardholder, merchant, issuer, or validating authority).

Public key cryptography between the web payment nodes and the mCommerce central switch may be implemented. Information from the channel may be encrypted using asymmetric key cryptography. The standard web encryption is 128 bits. The mCommerce channel security model may ensure that a public key is digitally signed by a certificate authority which encrypts web payment messages with a secret-key algorithm. In this implementation, messages encrypted with a public key cannot be decrypted by anyone except the mCommerce central switch, thus providing for confidentiality between the payment node and the central switch. Building on this security foundation, the OTPK is introduced to serve as the input into the web security process. The OTPK enables users to appropriate 2FA authentication. By using an OTPK, hackers and login hijackers need to know more than just the login information (e.g., username and password) to hack into a user account.

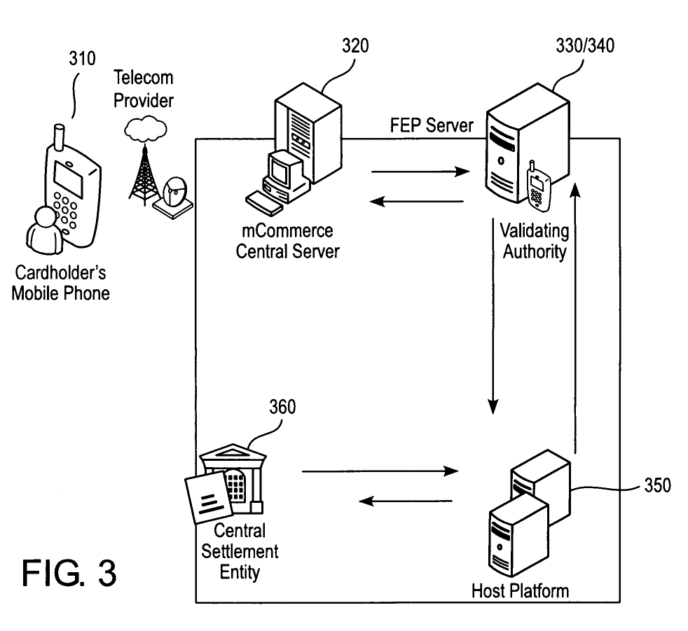

FIG. 3 is a diagram illustrating a system environment for authenticating a financial transaction tied to a preset monetary limit according to exemplary embodiments. FIG. 3 will be described generally as much of the process flow has been previously described in reference to FIGS. 1-2.

As illustrated in FIG. 3, the cardholder initiates a transaction using the mCommerce application on his or her mobile phone 310. The cardholder supplies all necessary information including the amount and his or her ATM static PIN on the mCommerce enabled mobile phone 310 to generate a new four digit dynamic passcode (“OTPK”) for that transaction, per this particular implementation.

The OTPK generated by the mobile device and the transaction data are encrypted and transmitted to the mCommerce central server 320 for authentication and validation via SMS or GPRS. Message transmission between the mobile device and the mCommerce central server 320 may be secured using DES encryption, for example, to ensure user integrity and security over the public network.

The mCommerce central server 320 (e.g., central switch) decrypts the transmitted data and the transaction is authenticated using the parameters contained in the decrypted message. The mCommerce central server 320 then transmits transaction and financial account data to a validating authority or issuer 330 for authorization of the transaction. If the transaction is a debit card transaction, it is switched to the appropriate participating bank where the account of the cardholder is domiciled. If the transaction is a reloadable card (i.e., a pre-paid card that can be reloaded with value), authorization is managed on the mCommerce central server 320. If the transaction concerns a third party payment scheme, the mCommerce central server 320 routes the payment for authorization to the scheme provider.

A front end processor (FEP 340), or a miniswitch, may be co-located on the network of the validating authority or issuer 330. The FEP 340 manages authorization and subsequent consummation of payment values into a host platform 350. A settlement entity 360 manages reconciliation of the inter bank transaction.

It will be appreciated by those skilled in the art that the present invention can be embodied in other specific forms without departing from the spirit or essential characteristics thereof. The presently disclosed embodiments are therefore considered in all respects to be illustrative and not restricted.

What is claimed is:

1. A method for authenticating a financial transaction, the method comprising:
retrieving and storing an identification data parameter associated with a mobile device at the mobile device;
receiving a personal identification number (PIN) from a user at the mobile device;
generating a dynamic variable that is determinable at more than one location at the mobile device;
calculating an One-Time Pass Code (OTPK) based on the identification data parameter, the PIN, and the dynamic variable at the mobile device;
associating the OTPK with a monetary limit amount; and
providing the OTPK to be used at a financial institution for withdrawing monetary funds up to the monetary limit amount.

2. The method of claim 1, wherein the identification data parameter is an identifier of the mobile device.

3. The method of claim 1, further comprising:
prompting by the mobile device for input of the PIN, wherein the PIN is an automated teller machine (ATM) PIN number of the user; and
validating the PIN by the mobile device.

4. The method of claim 1, wherein the dynamic variable is based on date and time.

5. The method of claim 1, wherein the OTPK is calculated using an algorithm that is updated on a periodic basis.

6. The method of claim 1, wherein the monetary limit amount is a predetermined amount set by the user during the generation of the OTPK and stored in a profile of the user at the server.

7. The method of claim 1, wherein a financial institution receives an ATM account number of the user through a financial transaction card.

8. The method of claim 7, wherein the financial transaction card is issued to the user.

9. The method of claim 7, wherein the financial transaction card is a substantial duplicate of the user's financial transaction card.

10. The method of claim 1, wherein if a possessor of the OTPK requests an amount greater than the monetary limit amount, a request for additional authorization of the new amount is sent to the user's mobile device if the user is setup for further authorization, and wherein, if the user is not setup for further authorization, the transaction is cancelled.

11. The method of claim 10, wherein if the request for additional authorization is not authorized by the user within a predetermined time period, the transaction is cancelled.

12. A method for authenticating a financial transaction, the method comprising:
receiving and storing at a server an identification data parameter associated with a mobile device and a personal identification number (PIN);
generating at the mobile device a dynamic variable that is determinable at more than one location;
transmitting the dynamic variable to the server to be used in decrypting the messages from the mobile device and authorizing the transaction;
receiving at the server an authorization request to authorize the transaction, the request including at least an unique financial account identifier, the OTPK generated by the mobile device, and a monetary limit amount associated with the OTPK generated by the mobile device;
the server determining whether the OTPK was generated by the mobile device based on the identification data parameter, the PIN, and the dynamic variable; and
authorizing the transaction request in response to the determining step.

13. The method of claim 12, wherein the identification data parameter is an identifier of the mobile device and the PIN is an automated teller machine (ATM) PIN number of the user.

14. The method of claim 12, wherein the dynamic variable is based on date and time.

15. The method of claim 12, wherein the monetary limit amount is a predetermined amount set by the user and stored in a profile of the user at the server during the synchronization of the OTPK with the server.

16. The method of claim 12, further comprising:
transmitting transaction and financial account data to a validating authority for authorization of the transaction, wherein if a possessor of the OTPK requests an amount greater than the monetary limit amount, a request for additional authorization of the new amount is sent to the user's mobile device if the user is setup for further authorization, and wherein, if the user is not setup for further authorization, the transaction is cancelled.

17. The method of claim 16, wherein if the request for additional authorization is not authorized by the user within a predetermined time period, the transaction is cancelled.

18. The method of claim 12, wherein a financial institution receives an ATM account number of the user through a financial transaction card.

19. The method of claim 18, wherein the financial transaction card is issued to the user.

20. The method of claim 18, wherein the financial transaction card is a duplicate of the user's financial transaction card.

21. A system for authenticating a financial transaction, the system comprising:
an authorization database receiving and storing an identification data parameter associated with a mobile device, a transaction card and a personal identification number (PIN);
a dynamic variable generator that generates a dynamic variable that is determinable at more than one location;
a receiver that receives an authorization request to authorize a transaction, the request including at least an unique financial account identifier, the OTPK generated by the mobile device, and a monetary limit amount associated with the OTPK; and
a processor determining whether the OTPK was generated by the mobile device based on the identification data parameter, the PIN, and the dynamic variable, and for authorizing the transaction request in response to the determining.

22. The system of claim 21, wherein the identification data parameter is an identifier of the mobile device and the PIN is an automated teller machine (ATM) PIN number of the user.

23. The system of claim 21, wherein the dynamic variable is based on date and time and is stored at the system.

24. The system of claim 21, wherein the monetary limit amount is a predetermined amount set by the user and stored in a profile of the user at the system.

25. The system of claim 21, further comprising:
an output device transmitting transaction and financial account data to a validating authority for authorization of the transaction, wherein if a possessor of the OTPK requests an amount greater than the monetary limit amount, a request for additional authorization of the new amount is sent to the user's mobile device if the user is setup for further authorization, and wherein, if the user is not setup for further authorization, the transaction is cancelled.

26. The system of claim 25, wherein if the request for additional authorization is not authorized by the user within a predetermined time period, the transaction is cancelled.

27. The system of claim 21, wherein a financial institution receives an ATM account number of the user through a financial transaction card.

28. The system of claim 27, wherein the financial transaction card is issued to the user.

29. The system of claim 27, wherein the financial transaction card is a duplicate of the user's financial transaction card.
